(19) United States
(12) Patent Application Publication
(10) Pub. No.: US 2016/0116181 A1
(43) Pub. Date: Apr. 28, 2016

(54) INDOOR AIR QUALITY SENSE AND CONTROL SYSTEM

(71) Applicant: AIRADVICE FOR HOMES, INC., Portland, OR (US)

(72) Inventors: Don Aultman, Portland, OR (US); Meindert Kleefstra, Vancouver, WA (US)

(21) Appl. No.: 14/924,518

(22) Filed: Oct. 27, 2015

Related U.S. Application Data
(60) Provisional application No. 62/069,702, filed on Oct. 28, 2014.

(51) Int. Cl. F24F 11/00; G05B 13/02

(52) U.S. Cl. CPC F24F 11/0017; F24F 11/0034; F24F 11/006; F24F 11/0076; G05B 13/026; F24F 2011/0026; F24F 2011/0027; F24F 2011/0032; F24F 2011/0035; F24F 2011/0047; F24F 2011/0063; F24F 2011/0068; F24F 2011/0075

(57) ABSTRACT

An indoor air quality (IAQ) system for sensing and controlling air quality within a structure is provided. The IAQ system includes a plurality of air quality sensor modules configured to sense IAQ parameters and remotely located within the structure. The IAQ system also includes an IAQ control hub including (i) a communication interface communicatively coupling the IAQ control hub to the plurality of air quality sensor modules and (ii) memory holding instructions that cause a processor to receive the IAQ parameters from the plurality of air quality sensor modules and if one of the IAQ parameters is outside a predetermined IAQ parameter range corresponding to the one of the IAQ parameters, request adjustment of control settings of a heating, ventilation, and air conditioning (HVAC) system to shift indoor air quality toward the predetermined IAQ parameter range.

### CROSS-REFERENCE TO RELATED APPLICATIONS

The present application claims priority to U.S. Provisional Patent Application No. 62/069,702, entitled “INDOOR AIR QUALITY SENSE AND CONTROL SYSTEM,” filed Oct. 28, 2014, the entire contents of which are hereby incorporated by reference for all purposes.

### BACKGROUND/SUMMARY

The quality of air within a home is measured based on the health and comfort of those living inside. Common factors that affect indoor air quality (IAQ) are carbon monoxide (CO), carbon dioxide (CO₂), volatile organic compounds (VOCs), mold, allergens, and other harmful airborne particulates and gases. These gases, airborne particulates, etc., can originate from a number of common household devices, furnishings, items, etc. These IAQ factors may induce eye, nose, and throat irritation and can cause headaches, dizziness, weakness, nausea, respiratory infections, bronchitis, lung cancer, and even death when for example harmful gases rise above dangerous levels. Moreover, numerous health conditions (e.g., as asthma, allergies, cystic fibrosis, etc.,) can be greatly exacerbated by the aforementioned air quality factors.

Heating, ventilation, and air conditioning (HVAC) systems are provided in houses, businesses, etc., to provide climate control in homes and other structures. HVAC systems can impact the IAQ inside these structures. In the past, users may manually operate different units in the HVAC system in a speculative manner to achieve a desired air quality. For instance, a user may manually increase the amount of air drawn into the house through an air conditioning unit to decrease an amount of smoke generated in a kitchen. However, people may not be aware of deteriorating air quality or may not recognize a deterioration in air quality until the air quality is well below healthy levels. Moreover, a user may not be aware of the appropriate way to improve air quality. Consequently, poor air quality may be experienced by people residing in a structure, despite their best efforts.

The inventor has recognized the above issues and has devised several approaches to address them. In one embodiment, an indoor air quality (IAQ) system for sensing and controlling air quality within a structure is provided. The IAQ system may include a plurality of air quality sensor modules configured to sense IAQ parameters and remotely located within the structure. The IAQ system may also include an IAQ control hub including (i) a communication interface communicatively coupling the IAQ control hub to the plurality of air quality sensor modules and (ii) memory holding instructions that cause a processor to receive the IAQ parameters from the plurality of air quality sensor modules and if one of the IAQ parameters is outside a predetermined IAQ parameter range corresponding to the one of the IAQ parameters, request adjustment of control settings of a heating, ventilation, and air conditioning (HVAC) system to shift indoor air quality toward the predetermined IAQ parameter range. In this way, the indoor air quality of a structure, such as a home, can be improved through programmed adjustment in the HVAC system based on remotely sensed air quality levels. As a result, the health of inhabitants in the structure can be improved through operation of a system to intelligently and automatically adjust equipment in the structure.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a block diagram illustrating an example indoor air quality (IAQ) system for monitoring and controlling indoor air quality according to an embodiment;

FIG. 2 shows exemplary heating, ventilation, and air-conditioning (HVAC) system components included in the IAQ system shown in FIG. 1;

FIG. 3 shows a use-case embodiment of an IAQ system; and

FIG. 4 shows a method for operating an IAQ system.

### DETAILED DESCRIPTION

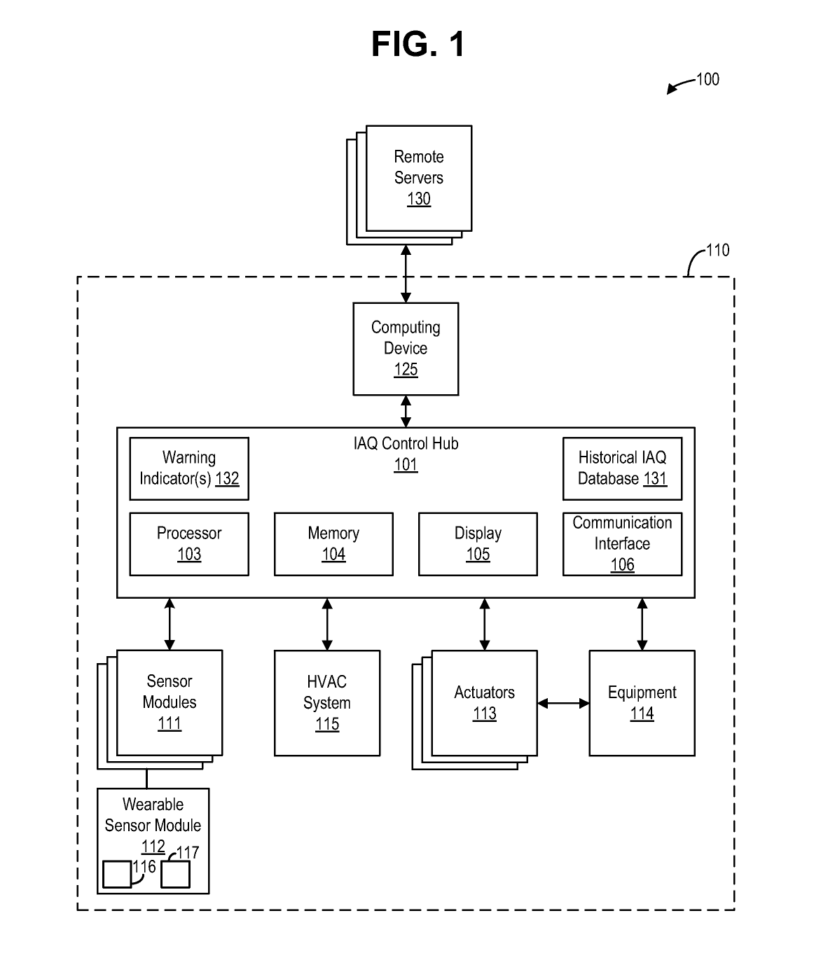

The present disclosure relates to sensing and controlling indoor air quality (IAQ) in homes and other structures. In particular, systems and methods are provided for sensing various parameters regarding the IAQ of a structure and controlling the heating, ventilation, and air conditioning (HVAC) equipment in the structure, so that the IAQ of the structure has acceptable IAQ levels (e.g., meet predetermined IAQ standards). IAQ standards may include standards published by acknowledged authorities such as: the United States Environmental Protection Agency (EPA); the Occupational Safety and Health Administration (OSHA); the World Health Organization (WHO); the American Lung Association; the American Society of Heating; Refrigerating and Air Conditioning Engineers (ASHRAE); and so on. As referred to hereinafter, a structure may comprise any building configured for human occupancy, such as a residential building (e.g., a room, an apartment, a house, etc.), commercial buildings, industrial buildings, vehicles, etc. Thus, as described further herein, an IAQ system such as the system depicted in FIG. 1 operates by continuously sensing the real-time level of various IAQ parameters, comparing those findings against predetermined acceptable IAQ ranges and cycling the appropriate components of HVAC equipment to address any deviation of actual versus desirable IAQ levels. Consequently, the likelihood of IAQ inducing various health conditions such as nausea, throat irritation, etc., and exacerbating various health conditions (e.g., asthma, allergies, etc.,) is reduced. For that reason, the health of the inhabitant of the structure can be improved.

FIG. 1 shows a block diagram illustrating an indoor air quality (IAQ) system 100 in accordance with the current disclosure. In particular, IAQ system 100 includes components for sensing and controlling the indoor air quality of a home 110 or any other conceivable structure. As described further herein, a central IAQ control hub 101 may be communicatively coupled to a plurality of sensor modules 111, a HVAC system 115, a plurality of actuators 113, and equipment 114. Components of IAQ system 100 may be positioned throughout and integrated within the home 110. In this way, IAQ control hub 101 may monitor and display data from the plurality of sensor modules 111 and responsively control the HVAC system 115 and the equipment 114 to improve the indoor air quality of the home 110.

A central component of IAQ system 100 may comprise an IAQ control hub 101 configured to aggregate data regarding indoor and outdoor air quality and to control the air quality within the home 110. IAQ control hub 101 may comprise a computing device for determining various control parameters and issuing control commands. As such, IAQ control hub 101 may include a processor 103 for executing instructions stored in memory 104 (e.g., non-transitory); a display 105 for displaying IAQ settings, IAQ data, IAQ alerts, and so on; and a communication interface 106 enabling IAQ control hub 101 to, as non-limiting examples, receive IAQ data from sensors and other sources as well as transmit IAQ control commands. In particular, communication interface 106 may enable IAQ control hub 101 to transmit and receive data using various communication protocols, including but not limited to short-range communication protocols (e.g., ZIGBEE, BLUETOOTH, WIFI, etc.). In one embodiment, components of IAQ control hub 101 may be housed in an enclosure which may be wall mounted or otherwise positioned within home 110. In this way, the IAQ control hub 101 may operate as a self-contained system that replaces a thermostat and adds many enhancements. Additionally or alternately, as described further herein, the IAQ control hub 101 may communicate with other sensors, devices, and systems within a structure, as well as communicating with off-site devices, people, and systems.

In previous HVAC systems a traditional thermostat compares a thermometer reading to temperature set-points to provide on/off decisions to a HVAC system. In contrast, as described further herein, the IAQ control hub 101 utilizes multiple sensor inputs to intelligently operate one or more components of the HVAC system 115 and/or other equipment 114 to improve air quality.

IAQ control hub 101 may include a variety of user controls and displays. In one example, IAQ control hub 101 may include controls that allow the user to adjust the operation of the HVAC system 115. Additionally, the HVAC system 115 may be intelligently controlled via the IAQ control hub 101 to provide enhanced air quality in the home 110. In such an example, the IAQ control hub 101 may be configured automatically to request adjustment of control setting of the HVAC system 115, discussed in greater detail herein.

In another example, IAQ control hub 101 may include a display 105 that allows the user to view current settings and conditions. In another example, IAQ control hub 101 may include a remote-control system that uses a general-purpose display, such as a television or computer monitor. In another example, IAQ control hub 101 may enable local or off-site review and control via the Internet or another data communication interface, such as cellular communication. In yet another example, IAQ control hub 101 may enable local or off-site review and/or control via telephone or another communication device using a graphic interface (e.g., graphics on a cell phone display), keypad, voice, or other means of display or control.

In yet another example, IAQ control hub 101 may include a display 105 that displays diagrams (e.g., floor plans), photographs, descriptive zone identifiers, and so on. In another example, the communication interface 106 of IAQ control hub 101 may include an infrared or otherwise wireless interface allowing bidirectional communication with other devices, such as a handheld remote control device or a long-range wireless device. The display options allowed with IAQ system 100 enable larger and improved graphics and more detailed information and instructions. The remote-control options provide convenience of control: rather than being at the fixed IAQ control hub 101, a user may adjust controls from another room, city, continent, and so on. For example, a user may adjust the heat for the entire home 110 or any zone in the home 110 using a handheld remote control in a bedroom. As another example, a traveling user may adjust the heat in the home 110 from another city, for example via a smart phone, so that the house is at a comfortable temperature when he or she arrives at the home 110.

IAQ control hub 101 may be communicatively coupled to one or more sensor modules 111 (e.g., sensor packages, devices, etc.,) that sense real-time levels of various IAQ parameters. IAQ parameters may include, but are not limited to, allergens, carbon dioxide (CO₂), carbon monoxide (CO), volatile organic compounds (VOCs), temperature, relative humidity, radon, air pressure, formaldehyde, particulates, formaldehyde, oxides of nitrogen, oxides of sulfur, mold, and so on. As such, each of the sensor modules 111 may include one or more sensors. For example, sensor modules 111 may include particle sensors configured to differentiate and measure particles ranging from 1.0 to 10.0 microns. Sensor modules 111 may further include a transceiver for transmitting sensor data to the IAQ control hub 101. Such sensor modules 111 may be located indoors and/or outdoors, and may transmit sensed data in real-time via wireless and/or wired connections to IAQ control hub 101.

Sensor modules 111 may additionally include one or more sensors configured to sense parameter that can affect IAQ parameters. For example, sensor modules 111 may include occupancy sensors, activity sensors, sunlight sensors, ground-moisture sensors, and so on.

In one example, one of the sensor modules 111 may be enclosed in IAQ control hub 101. In another example, one of the sensor modules 111 may be enclosed in IAQ control hub 101 and one or more additional sensor modules 111 may be remotely positioned throughout the home 110 to extend the monitoring range of IAQ control hub 101. In yet another example, sensor modules 111 may comprise a wearable sensor module 112 that a person, or user, may wear while within the home 110. For example, the wearable sensor module may be placed in a user's pocket, clipped to an article of clothing, or otherwise secured to their person. In such an example, sensor modules 111 may provide the user with IAQ information regarding the user's immediate vicinity. Furthermore, the sensor modules 111 may be configured to provide an alarm if local IAQ parameters are measured outside of a specified range. For example, sensor modules 111 may include a dust sensor and may audibly, visually, haptic (e.g., vibrations), and/or otherwise provide an alarm to notify the user of high amounts of dust in the immediate proximity of the user. In this way, the user may avoid areas of home 110 with potential health hazards that may be otherwise unnoticed by the user. As a result, the user's health can be improved.

The wearable sensor module 112 may include a communication component 116 enabling wireless communication protocols, standards, etc., to be implemented. Many types of wireless communication have been contemplated such as (a) Bluetooth, (b) Wi-Fi, and/or (c) a wireless personal area network. In one specific example, the communication component can include a module (e.g., ZigBee module) for providing a software suite of communication protocols for creating personal area networks. By providing personal area network functionality the cost of the wearable sensor module can be reduced when compared with other wireless communication hardware associated with Wi-Fi and Bluetooth. The wearable sensor module 112 may also include one or more warning indicators 117 for warning a user of low air quality. The warning indicator may include an audio warning indicator, a visual warning indicator, and/or a haptic warning indicator. Furthermore, while alarm capabilities are described with respect to the wearable sensor module 112, it should be appreciated that any of the sensor modules 111 may include alarm capabilities to alert users of the presence and location of low IAQ.

The IAQ system 100 may include the HVAC system 115 communicatively coupled to the IAQ control hub 101. IAQ control hub 101 may transmit control signals to HVAC system 115 to adjust operation of the HVAC system 115. In some examples, IAQ control hub 101 may be used to automatically control operation of the HVAC system 115. Specifically, the IAQ control hub 101 may automatically control operation of the HVAC system 115 based on a number of sensed IAQ parameters and/or other parameters sensed via the sensor modules 111. In particular, the HVAC system 115 may be intelligently controlled via the IAQ control hub 101 to shift indoor air quality towards desirable levels, ranges, etc., based on the sensed IAQ parameters. It will be appreciated that the IAQ parameter ranges can include an array of values or a single set-point value. Additionally, the IAQ system 100 can operate to continuously sensing the real-time level of various IAQ parameters, comparing those findings against desirable IAQ parameters. The desirable IAQ parameter may be predetermined and may, in one example, be standards published by acknowledged authorities. After the real-time levels of the IAQ parameters the IAQ control hub 101 can cycle the appropriate components of the HVAC system 115 and/or equipment 114 to address a deviation between the actual versus desirable IAQ parameters. Consequently, air quality in the structure can be intelligently and automatically improved.

For example, if one of the sensor modules 111 senses a high level of carbon monoxide in a room of the home 110, IAQ control hub 101 may transmit command signals to HVAC system 115 to adjust operation of fans and vents to direct fresh air to the room. As such, the level of carbon monoxide in the room can be reduced, enabling the health of inhabitants of the home 110 to be improved.

In another example, if one of the sensor modules 111 senses a higher than desirable level of mold, the IAQ control hub 101 may request adjustment of the HVAC system 115 to decrease the temperature in the house 110 and/or decrease the humidity in the house to decrease mold, thereby improving air quality.

In yet another example, other sensed parameters, such as occupancy, may be taken into account when controlling adjustment of the HVAC system 115. For instance, if there is a high occupancy of inhabitants in the home the fans and vents in a greater number of rooms may be operated and/or the fans may be driven at a higher level.

Furthermore, it will be appreciated that the IAQ control hub 101 can request cooperative adjustment of control settings of various HVAC system components to decrease levels of different IAQ factors, in one example. For instance, a cooling device and a dehumidifier may be jointly operated to decrease indoor mold formation. In another example, an air cleaner and cooling device may be operated together to reduce an amount of airborne pollen. In other examples, different IAQ factors may require contradictory HVAC system adjustments and therefore the health risks of the IAQ factors may be compared to one another to determine a desirable HVAC system control scheme. For instance, reduction in harmful gases such as radon, CO, etc., may take precedence over pollen or mold reduction. Therefore, HVAC system adjustments targeted to reduce harmful gases take place prior to, or in some cases override, HVAC system adjustments targeted to reduce pollen or mold.

Additionally, the requested adjustment of the control settings of the HVAC system may override user selected set-points, such as temperature set-points of a heating device and/or a cooling device. For instance, to reduce CO levels inside the home it may be desirable to flow outside air into the home through an air conditioning unit which moves the indoor temperature away from a user requested set-point.

The IAQ system 100 may optionally include one or more actuators 113 communicatively coupled to the IAQ control hub 101 and configured to physically control equipment 114 (e.g., IAQ equipment) responsive to control signals from the IAQ control hub 101. In some examples, equipment 114 may be communicatively coupled to the IAQ control hub 101 to provide feedback and/or receive control signals directly from the IAQ control hub 101. Equipment 114 may comprise any technology relating to IAQ. For example, equipment 114 may include adjustable window covering (curtains, blinds, etc.), adjustable windows, adjustable doors, moveable insulation, etc. It will be appreciated that in some examples, the equipment 114 and/or actuators 113 may be included in the HVAC system 115.

In some examples, the IAQ system 100 may be configured to implement various energy efficiency functions/operations. For example, equipment 114 may include equipment relating to temperature control, such as curtains, blinds, moveable insulation, and the like, thereby providing IAQ control hub 101 additional control over the environmental conditions of the home 110. For example, the IAQ control hub 101 may be programmed to maintain a specified temperature throughout at least a portion of the home 110. The IAQ control hub 101 may adjust (e.g., close/open) curtains or blinds via actuators 113 to reduce energy usage of the HVAC system 115. In this way, the IAQ system 100 can be operated to achieve energy efficiency gains in tandem with the IAQ control schemes, described above. Additionally in one example, the energy needs of the method of HVAC system adjustment for improving air quality may be taken into account when selecting the adjustment method. For instance, to decrease temperature in the home 110 to decrease mold, blinds may be automatically closed during the day to reduce heat gain as opposed to operating an air conditioning unit to reduce indoor air temperature with less energy consumption.

IAQ control hub 101 may optionally be communicatively coupled to a computing device 125 to perform advanced data analysis on sensed data and/or provide an interface with a plurality of remote servers 130. Remote servers 130 may comprise, for example, external data sources providing weather forecast information (e.g., National Oceanic and Atmospheric Administration, and so on). For example, IAQ control hub 101 may receive information based on current, forecast, and historic weather. Such information may include health-related information such as pollen count or air pollution warnings. IAQ control hub 101 may determine HVAC control decisions and adjustments based on data analysis results and/or data provided by remote servers 130. Further, IAQ control hub 101 may display or otherwise present the data analysis results and/or weather forecast information provided by remote servers 130, and even further, may store such information in non-transitory memory 104 for later use.

Additionally, IAQ parameters sensed by the sensor modules 111 may be sent to the remote servers 130 and stored in a remote historical IAQ database or may be stored on a local historical IAQ database 131. These previously sensed IAQ parameters may be referred to as historical IAQ data. Subsequently, the historical IAQ parameters may be taken into account when adjusting the control settings of the HVAC system 115 to improve air quality, discussed in greater detail herein. Additionally or alternatively, the historical IAQ parameters may be stored locally within the IAQ control hub 101. These, historical IAQ parameters may also be used as inputs to adjust the control settings of the HVAC system 115. For example, there may be historically high levels of allergens, such as pollen, detected during spring months in the home 110. Therefore, the HVAC system 115 may be slated to operate an air cleaner at a greater rate during these spring months to remove a greater amount of allergens from the air.

IAQ control hub 101 may communicate information to and from a remote facility. Transmitted information may include, for example, sensor information, user settings and adjustments, system diagnostic information, and so on. Received information may include messages to users or occupants, information that causes a change in the performance of the IAQ control hub 101 or HVAC system 115, and so on. The data acquired by the IAQ control hub 101 may be used, for example, to populate a database that can be used for statistical analysis and research, to analyze individual and aggregate user comfort preferences, to translate user preferences into automatic program adjustments that are transmitted back to the IAQ control hub 101, for medical health applications, for insurance applications, for evidence of regulatory compliance, and so on. In some examples, IAQ control hub 101 may additionally transmit photographs to be used to evaluate or provide assurance that there is no problem.

In one example, IAQ control hub 101 may incorporate a calendar which allows automatic adjustment for seasonal changes. This differs from current devices which contain a clock and week-long program schedule, but do not use an annual calendar. This calendar (and associated clock) may be automatically set from an external signal or information source. As an illustrative example, on a winter morning when the indoor air is sensed at sixty degrees Fahrenheit, the IAQ control hub 101 may turn on a component of the HVAC system 115 (e.g., furnace) or the equipment 114 to raise the temperature. As another example, on a summer morning, the HVAC system 115 may continue to draw in cooler air from outdoors in anticipation for a hot day. In this way, seasonal behavior differences of the IAQ system 100 may result in improved comfort for users and energy efficiency without manual adjustment of the HVAC controls.

In another example, the IAQ control hub 101 may incorporate climate and location information. For example, the IAQ control hub 101 may provide a means for the user, operator, or installer to identify the climate type or geographic location so that the automatic operation of the system may be adjusted to the climate in which the IAQ control hub 101 is operating. This may be accomplished by identifying the climate zone (or region), by identifying a ZIP or postal code, and so on. The climate information may also be transferred via a connection to a remote facility or system, such as remote servers 130. The climate information may be used in conjunction with the calendar feature described herein above to adapt the system performance to specific climates and seasons.

Further in one example, the IAQ control hub 101 may predict weather changes based on locally sensed data, for example by a barometer included in one of the sensor modules 111. The IAQ control hub 101 may apply predicted weather changes to control decisions and adjustments for the HVAC system 115.

In yet another example, the IAQ control hub 101 may display or otherwise present weather information. This information may include, for example, health-related information such as pollen count or air pollution warnings. Such information may be determined from sensed IAQ levels obtained via sensor modules 111 and/or from remote servers 130.

In an additional example, the IAQ system 100 may include an adaptive learning system that learns user preferences from previous settings, conditions, sensor readings, and override adjustments, and makes predictions based on this history. In some examples, the IAQ control hub 101 may include the adaptive learning system. In other examples, the adaptive learning system may be included in remote servers 130 that process data and transmit back the learned predictions to IAQ control hub 101. The learned predictions may be used to make automatic adjustments to the HVAC system 115. Furthermore, the adaptive system may adjust operation of the HVAC system 115 (e.g., timing, fan speed) to accommodate the time required to affect a change (e.g., heating and/or cooling) in the indoor air. In this way, the IAQ system 100 may provide improved user comfort, convenience, energy efficiency, and air quality.

In yet another example, the IAQ control hub 101 may select heating or cooling methods. For example, the IAQ control hub 101 may select between natural gas and electricity for heating, and/or may select between ventilation and air refrigeration for cooling. In some examples, the lowest cost method may be automatically selected. In other examples, during peak electrical demand the system may switch to another energy source. In yet other examples, if one energy source fails the system 100 may automatically switch to another energy source. The IAQ system 100 may base these switching decisions on information received from a remote facility or system, such as remote servers 130. This information may include, for example, current energy prices or demand. Alternatively or additionally, prices, peak demand times, and other information relevant to method switching may be entered into the system by the user, operator, installer, or service provider.

Additionally, the IAQ control hub 101 may provide information regarding energy efficiency. For example, the IAQ control hub 101 may display information regarding the energy consumption per square foot of indoor space, heat loss, flu gas composition, and so on. Such information may be presented directly to the user or occupant, or to a remote entity such as a service provider. Calculations and recommendations may be performed locally or by a remote facility or system.

The IAQ system 100 may be configured to provide warnings based on a variety of scenarios. In one example, the IAQ system 100 may provide a warning in the event that IAQ has deviated from acceptable levels. The warning may take multiple forms, including an audible warning such a beep, a visual warning such as an alphanumeric display, a haptic warning, a text message alert, an email alert, and so on. Such warnings may be produced, for example, by the IAQ control hub 101 to trigger warning indicator(s) 132. The warning indicator(s) 131 may include one or more of an audio warning indicator, a visual warning indicator, and a haptic warning indicator.

In another example, the IAQ control hub 101 may push the warning to a computing device possessed by a remote medical support personnel (e.g., caretaker, nurse, doctor, emergency medical service provider, etc.,) via text message, email, and/or other suitable form of communication. In this way, medical support personnel can be alerted of a user's medical risk/problem and take action to improve the health of a patient.

In an additional example, the IAQ system 100 may provide an alarm in the event of an equipment service or malfunction issue. Such an alarm may be displayed locally, for example on a display of the IAQ control hub 101, or may be sent to the homeowner or a remote HVAC service provider via text or email. The transmitted data may also include sensor readings or information used to diagnose sensor problems. An example service issue may comprise a dirty air filter in the HVAC system 115. Pressure levels located upstream and downstream of the air filter and reading significantly different pressure levels would indicate a clogged filter. In addition to being transmitted, this information may be stored locally in non-transitory memory 104 for later review. In this way, a HVAC service provider or another person specified for maintaining the HVAC system 115 may be alerted to service the HVAC system 115, thereby reducing the number of service or maintenance visits and maintenance costs in general.

While the description herein above refers to a residential home 110, the structure may comprise any structure and the systems and methods described herein may be applied to a variety of scenarios. For example, the IAQ system 100 may be applied to animal health and comfort by implementing the IAQ system 100 in farm production (e.g., poultry barns, rabbit barns, etc.), zoos, kennels, veterinary hospitals, animal care areas in research facilities, and so on. As another example, the IAQ system 100 may be implemented in healthcare facilities, thereby enabling hospitals and long-term healthcare facilities, for example, to ensure the health of patients. In yet another example, the IAQ system 100 may be deployed in offices, brick and mortar retailers, factories, etc.

Furthermore, data collected by the IAQ control hub 101 may be used as a means of auditing and regulating such facilities. As another example, health maintenance organizations (HMOs) may benefit from IAQ system 100 implemented in the homes of their clients. For example, the IAQ system 100 may ensure good indoor air quality, which in turn provides health benefits. Furthermore, the sensor modules 111 may detect smoke and allergens detected in the air, and the IAQ control hub 101 may report these measurements to the HMO to help in diagnosing and monitoring client health problems and risks.

Additionally, the IAQ control hub 101 may serve as a communication hub that can send and receive information to and from a residence, building, vehicle, and so on. Examples of information categories include health status, security, and building or home automation.

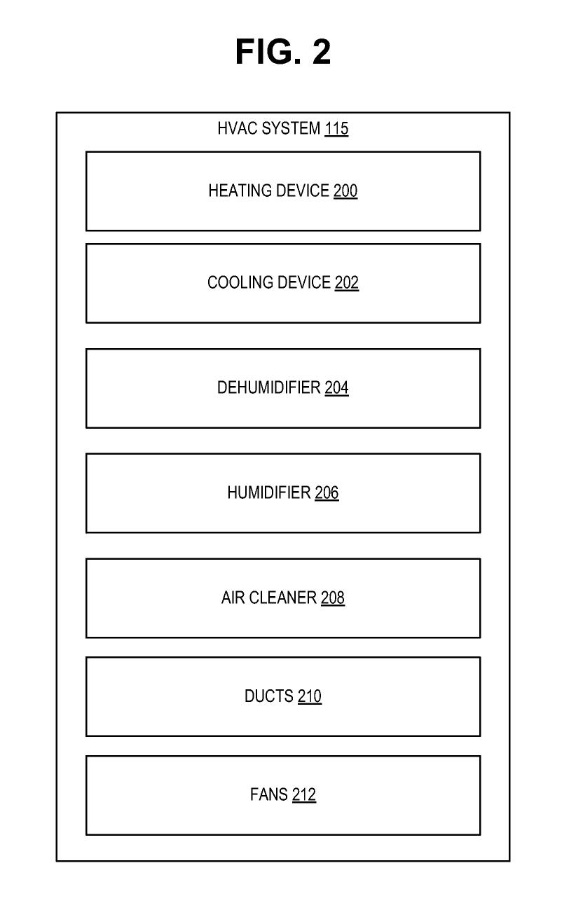

FIG. 2 shows exemplary devices, component, etc., which may be included in the HVAC system 115. The HVAC system components may include a heating device 200 for heating air in the indoor environment. Exemplary heating devices include a fuel combustion heater (e.g., gas furnace), an electric heater (e.g., baseboard heaters), underfloor heating, radiator, etc. The HVAC system 115 may also include a cooling device 202 such as an air conditioner, an evaporative cooler, ground-coupled heat exchanger, etc. The cooling device 202 reduces air temperature of the indoor environment. In some examples, some of the HVAC system components may be integrated into a single unit. For instance, both the heating device 200 and the cooling device 202 may be integrated into a common unit, such as a heat pump.

The HVAC system 115 may also include a dehumidifier 204, humidifier 206, air cleaner 208, ducts 210, and fans 212. The dehumidifier 204 is configured to reduce the humidity of air in the indoor environment. On the other hand, the humidifier 206 is configured to increase humidity of the air. Additionally, the air cleaner 208 may be configured to filter air via absorbents and/or catalysts, for instance.

The ducts 210 can enable conditioned air from various HVAC devices to be delivered to selected sections (e.g., rooms) of the structure. Additionally, the fans 212 may be provided in the HVAC system 115 to produce airflow through the ducts, rooms, etc. In some examples, fans may be integrated into the heating device 200 cooling device 202, air cleaner 208, etc.

Each of the heating device 200, cooling device 202, dehumidifier 204, humidifier 208, air cleaner 210, and fans 212 may be controlled via the IAQ control hub 101, shown in FIG. 1, to achieve desired levels of indoor air quality based on the IAQ parameters sensed via the sensors 111, shown in FIG. 1. As described herein, improvements in air quality include reducing levels of harmful gases and particulates in the air within the structure.

Each of the devices shown in FIG. 2 may be operated to achieve acceptable levels of air quality. As such, each device can be cooperatively operated to improve air quality, in some instances. For instance in one example use-case, a CO sensor may detect an unhealthy level of CO concentration in the air. Responsive to determining the harmful level of CO the cooling device 202 may be instructed to increase fresh air flow into the structure and the air cleaner 208 may be instructed to increase airflow there-through. These operations may be carried out at overlapping time intervals. In such an example, it may be determined that the heating device 200 is contributing to the high level of CO. Therefore, the output of the heating device 200 may also be decreased (e.g., discontinued) to further decrease levels of CO in the structure.

In another exemplary use-case, a high level of mold may be detected in the structure. To decrease mold the dehumidifier 204 may be operated to reduce the humidity in the indoor environment and an output of the cooling device 200 may be increased to decrease the temperature of the air in the indoor environment. In this way, conditions conducive to mold formation can be diminished to improve IAQ within the structure.

In another exemplary scenario, a pollen sensor may detect higher than desired levels of allergy inducing pollens. Responsive to the detection of these high pollen levels the IAQ control hub 101 can instruct the HVAC system 115 to circulate a greater amount of air through the air cleaner 208. Additionally in such an example, the amount of air draw into the HVAC system from the external environment can also be reduced, to reduce pollen levels. In this way, air quality again can be improved via cooperative operation of multiple HVAC system components.

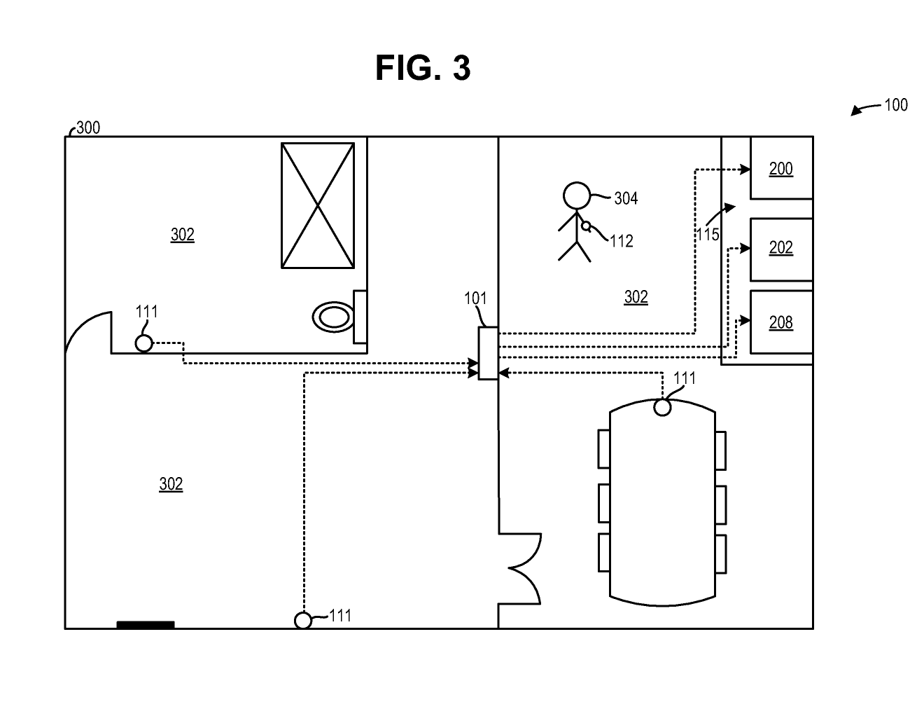

FIG. 3 shows an exemplary implementation of the IAQ system 100 within a residential home 300. However as previously discussed, the IAQ system 100 can be included in a multitude of structures.

The home 300 includes a plurality of rooms 302 and a HVAC system 115 for providing conditioned air to the house. The HVAC system 115 including the heating device 200, the cooling device 202, and air cleaner 208. It will be appreciated that ducting can provide conditioned (e.g., heated, cooled, dehumidified, etc.,) air transport to different locations in the house.

The IAQ control hub 101 is depicted in FIG. 3. The IAQ control hub 101 may include a display (e.g., touch display) and input devices (e.g., keyboard, touchpad, etc.,) as previously discussed. The display and input devices enable a user to interact with the IAQ control hub 101 and to receive information. This information may include alerts, current air quality levels, weather conditions, etc.

As shown, the IAQ control hub 101 receives inputs from the plurality of sensors 111 and the wearable sensor module 112 secured to a user 304. It will be appreciated that the user may move around the house and the wearable sensor module 112 may take a plurality of dynamic sensor readings. Each of these sensor readings therefore has a different corresponding location. Thus, the IAQ control hub 101 may be configured to determine the location of the wearable sensor module 112.

As indicated, the IAQ control hub 101 is in electronic communication with the heating device 200 and the cooling device 202 and other components in the HVAC system 115. Control commands may be sent to each of the heating device 200 and the cooling device 202 to shift the indoor air quality toward acceptable IAQ parameter ranges (i.e., predetermined IAQ parameter ranges), as previously discussed. For instance, the techniques for reducing, CO, mold, pollen, discussed above, may be implemented by the IAQ control hub 101 and HVAC system 115, shown in FIG. 3.

Furthermore, the control commands may be dynamically adjusted as the user 304 moves around the home 300 with the wearable sensor module 112. For instance, the wearable sensor module 112 may be configured to sense airborne allergens. When a user walks into a room with a higher than desirable level of allergens the room may be targeted by the IAQ control hub 101 for increased clean air circulation, such as filtered air from the heating or cooling devices and/or an air cleaner. In this way, the air quality in the immediate vicinity of the user 304 can be improved in real-time as the user travels around the home 300. As a result, targeted areas of the home can be selected for rapid air quality improvement, thereby improving the user's health. Moreover, using a wearable sensor module enables a greater range in air quality samples in a multitude of locations in the house to be taken. Therefore, a more complete picture of the air quality around the home can be determined.

Additionally in one scenario, subsequent to adjustment of the HVAC system 115 to improve air quality, a higher than desired level of harmful gases, particulates, etc., may be sensed via one of the sensor modules 111. When the elevated levels of harmful IAQ gases, particulates, etc., persist, an air quality warning may be triggered via the IAQ control hub 101. The air quality warning may locally trigger audio, visual, and/or haptic warning indicators within the IAQ control hub 101. For example, a flashing light and/or audio track indicating the poor indoor air quality may be activated in the hub to alert the inhabitants of the poor air quality.

Additionally or alternatively, the air quality warning may be sent to one or more of the sensor modules 111, such as the wearable sensor module 112, to trigger activation of audio, visual, and/or haptic warning indicators in the sensor modules. In this way, warning triggered in a number of rooms in the house to quickly alert inhabitants of deteriorating air quality. Consequently, the inhabitant may take corrective actions to reduce their risk, such as leaving the home 300, increasing outdoor airflow into the home, etc.

The air quality warning may also be sent to a remote computing device to alert selected individuals of the poor air quality. The remote computing device (e.g., mobile computing device) may be owned by an inhabitant of the house or medical personnel (e.g., nurse, doctor, home care technician, emergency medical service personnel, etc.) In this way, inhabitants or medical personnel can be quickly alerted of the poor air quality at remote locations. As a result, corrective actions can be quickly taken to improve the health of people currently residing in the home.

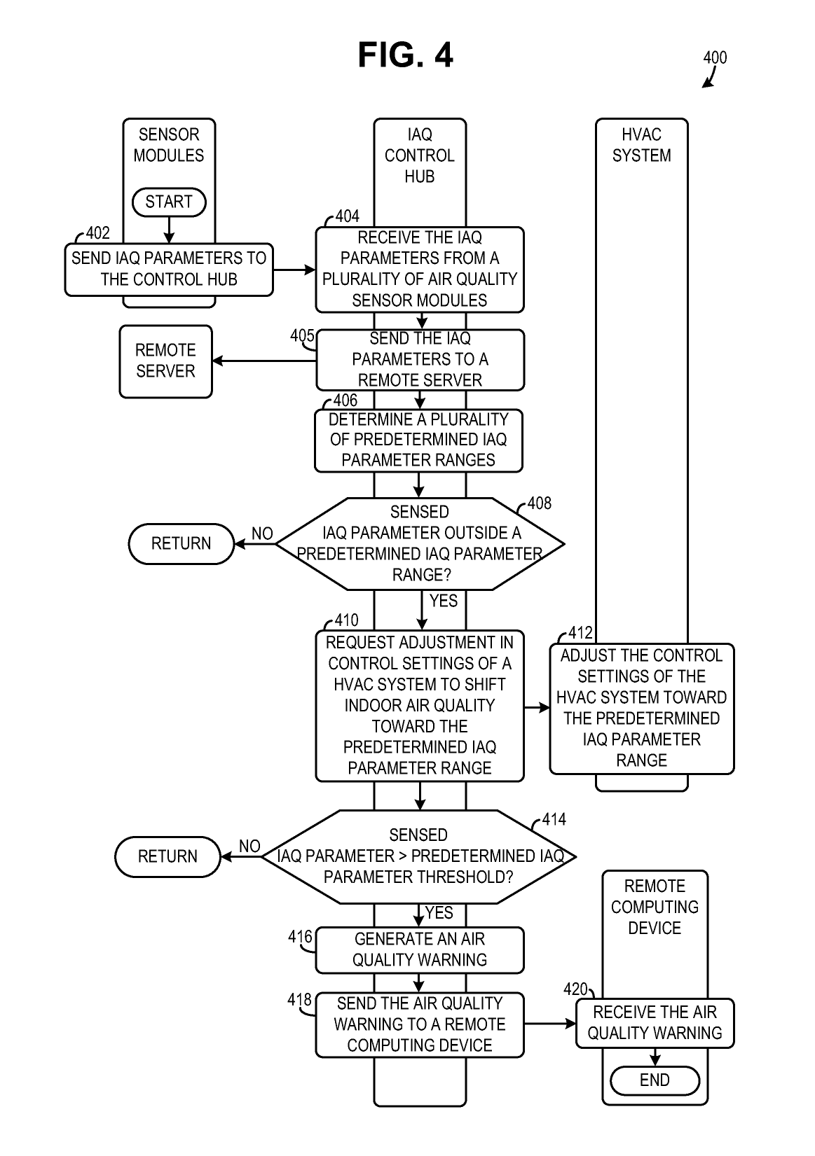

FIG. 4 shows a method 400 for operating an IAQ system. The method 400 may be implemented by the IAQ system described above with regard to FIGS. 1-3 or another suitable IAQ system. The method 400 enables IAQ values to be remotely sensed and subsequently used to control a HVAC system to improve IAQ in a home or other structure.

At 402 the method includes sending a plurality of IAQ parameter to the IAQ control hub, the parameters sensed by a plurality of remotely located sensors. As previously discussed, a multitude of sensor types have been contemplated, such as CO sensor, radon sensors, mold sensors, allergen sensors, etc. Thus, the IAQ parameter may be concentrations, levels, etc., of CO, radon, mold, allergens, etc. It will be appreciated that the sensed IAQ parameters may be periodically sampled and sent to the IAQ control hub.

Next at 404 the method includes receiving the plurality of IAQ parameters from the plurality of air quality sensor modules. At 405 the method includes sending the IAQ parameters to a remote server. In this way, the remote server can gather historical IAQ data. Additionally or alternatively, historical IAQ data may be stored in the IAQ control hub. It will be appreciated that this historical IAQ data may be subsequently used to determine set-points of HVAC system equipment that will improve air quality. Thus, the historical IAQ data may be sent back to the IAQ control hub for downstream HVAC system control setting adjustment. However, in other examples the historical IAQ data may be stored locally in the IAQ control hub.

Next at 406 the method includes determining a plurality of predetermined IAQ parameter ranges. Each of the IAQ parameter ranges may correspond to an IAQ parameter sensed via one of the IAQ sensors. Additionally, the predetermined IAQ parameter ranges may be determined based on IAQ standards gathered from third party devices. Specifically, the IAQ standards may be based on standards set by acknowledged authorities such as: the EPA; OSHA; WHO, etc.

At 408 the method determines if one of the sensed IAQ parameters is outside a predetermined IAQ parameter range corresponding to the IAQ parameter. In this way, it can be determined if the IAQ parameters are not at desirable levels. If one of the sensed IAQ parameters is not outside the corresponding IAQ parameter range (NO at 408) the method returns to the start or in other examples may end. However, if one of the sensed IAQ parameters is outside the corresponding predetermined IAQ parameter range (YES at 408) the method advances to 410. At 410 the method includes requesting adjustment in control settings of a HVAC system to shift indoor air quality toward the predetermined IAQ parameter range. In one example, the control settings may be determined based on the deviation of the sensed IAQ parameter from the acceptable IAQ ranges. Further in one example, requesting adjustment in the control settings including requesting cooperative adjustment of control settings of multiple distinct HVAC devices included in the HVAC system. In this way, different HVAC device can be jointly operation to quickly and efficiently improve air quality.

At 412 the method includes adjusting the control settings of the HVAC system toward predetermined IAQ parameter range. For instance, control setting of a heating device, cooling device, air cleaner, and/or dehumidifier may be adjusted to improve air quality.

Additionally as previously discussed, one of the sensor modules may be a wearable sensor module. In such an example, the control settings of the HVAC system may be adjusted based on the dynamic location of the wearable sensor module corresponding to the IAQ parameter sensed via the wearable sensor. For instance, fans directing airflow to a room where the wearable sensor is located may be driven with increased power to increase airflow through the room to improve air quality.

In one example, the control settings of the HVAC system may also be adjusted based on energy consumption of the HVAC system. For instance, there may be multiple possible HVAC system adjustments that could be used to improve air quality. Energy consumption of various corrective actions may be compared to determine an energy efficient way to improve air quality. For instance, the HVAC system adjustment that uses the least amount of energy may be selected. In other instances, air quality improvement actions may be delayed or inhibited when the corrective actions require energy consumption that is outside an acceptable level.

Further in one example, historical IAQ data may also be taken into account when adjusting the control settings of the HVAC system. For instance, high levels of mold may be detected in the winter, therefore a dehumidifier included in the HVAC system may be driven at a higher level during winter months so as to proactively decrease the factors that lead to increased mold formation.

Next at 414 the method includes determining if the sensed IAQ parameter is greater than a predetermined IAQ parameter threshold. In one example, the predetermined IAQ parameter threshold may correspond to an unhealthy level gases, particulates, etc., within the air. Further in one example, the predetermined IAQ parameter threshold may be correlated to the predetermined IAQ parameter range, discussed with regard to step 408.

If the sensed IAQ parameter is not greater than the predetermined IAQ parameter threshold (NO at 414) the method returns to the start. However, if the sensed IAQ parameter value is greater than the predetermined IAQ parameter threshold (YES at 414) the method advances to 416.

At 416 the method includes generating an air quality warning. Generating the air quality warning may include triggering warning indicators within the structure, such as audio, visual, and/or haptic indicators. Additionally or alternatively, the air quality warning may be sent to the sensor modules. In this way, inhabitants of the structure can be alerted of unhealthy air quality levels, enabling the inhabitant to take risk mitigating actions, such as leaving the structure, openings window, finding the source of the unhealthy gas, particulates, etc. Next at 418 the method includes sending the air quality warning to a remote computing device. It will be appreciated that the remote computing device may be owned by one of the inhabitants or medical personnel. At 420 the method includes receiving the air quality warning at the remote computing device. Responsive to receiving the air quality warning the remote computing device may trigger audio, visual, and/or haptic indicators. In this way, another option is provided to alert inhabitants and/or medical personal of deteriorating air quality.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An indoor air quality (IAQ) system comprising:
a plurality of air quality sensor modules configured to sense IAQ parameters and remotely located within the structure; and
an IAQ control hub including (i) a communication interface communicatively coupling the IAQ control hub to the plurality of air quality sensor modules and (ii) memory holding instructions that cause a processor to:
receive the IAQ parameters from the plurality of air quality sensor modules; and
if one of the IAQ parameters is outside a predetermined IAQ parameter range corresponding to the one of the IAQ parameters, request adjustment of control settings of a heating, ventilation, and air conditioning (HVAC) system to shift indoor air quality toward the predetermined IAQ parameter range.

2. The IAQ system of claim 1, where requesting adjustment of the control settings of the HVAC system includes requesting cooperative adjustment of control setting of multiple distinct HVAC devices included in the HVAC system.

3. The IAQ system of claim 1, where IAQ parameters include a concentration of one or more of volatile organic compounds, allergen particulates, mold, carbon dioxide, carbon monoxide, radon, formaldehyde, oxides of nitrogen, and oxides of sulfur within the structure.

4. The IAQ system of claim 1, where one of the air quality sensor modules is a wearable sensor module configured to secure to a user, the wearable sensor module configured to sense one of the IAQ parameters.

5. The IAQ system of claim 4, where the request for adjusting the control settings is based on a dynamic location of the wearable sensor module in the structure associated with the IAQ parameter sensed by the wearable sensor module.

6. The IAQ system of claim 4, where the wearable sensor module includes one or more of an audio warning indicator and a visual warning indicator and where the instructions are further configured to cause the processor to generate an air quality warning when one of the IAQ parameters is outside a predetermined range and send the air quality warning to the wearable sensor module, the air quality warning configured to request activation of the audio warning indicator and/or visual warning indicator.

7. The IAQ system of claim 1, where the instructions are further configured to cause the processor to, subsequent to the adjustment of the control settings, generate an air quality warning when the one of the IAQ parameters is greater than a predetermined IAQ parameter threshold.

8. The IAQ system of claim 7, where the air quality warning is sent to a remote computing device.

9. The IAQ system of claim 7, where the air quality warning locally triggers one or more of an audio warning indicator, a visual warning indicator, and a haptic warning indicator in the IAQ control hub.

10. The IAQ system of claim 1, where the instructions are further configured to cause the processor to receive historical IAQ data from a historical IAQ database and where the request for adjustment of the control settings is based on the historical IAQ data, the historical IAQ data including prior IAQ parameters sensed by the plurality of air quality sensor modules.

11. The IAQ system of claim 10, where the instructions are further configured to cause the processor to adjust the control settings of the HVAC system based on the historical IAQ data.

12. The IAQ system of claim 1, where the instructions are further configured to cause the processor to adjust the control settings of the HVAC system based on energy consumption of the HVAC system.

13. A method for operating an indoor air quality (IAQ) system comprising:
at an IAQ control hub, receiving IAQ parameters from a plurality of air quality sensor modules remotely located within the structure; and
if one of the IAQ parameters is outside a predetermined IAQ parameter range corresponding to the one of the IAQ parameters, requesting adjustment of control settings of a heating, ventilation, and air conditioning (HVAC) system to shift indoor air quality toward the predetermined IAQ parameter range.

14. The method of claim 13, where requesting adjustment of the control settings of the HVAC system includes requesting cooperative adjustment of control setting of multiple distinct HVAC devices in the HVAC system.

15. The method of claim 13, further comprising, at the IAQ control hub, subsequent to the adjustment of the control settings, generating an air quality warning when the one of the IAQ parameters is greater than a predetermined IAQ parameter threshold and sending the air quality warning to a remote computing device.

16. The method of claim 13, where one of the air quality sensor modules is a wearable sensor module configured to secure to a user, the method further comprising adjusting the control settings based on a dynamic location of the wearable sensor module in the structure associated with the IAQ parameter sensed by the wearable sensor module.

17. The method of claim 13, where IAQ parameters include a concentration of one or more of volatile organic compounds, allergen particulates, mold, carbon dioxide, carbon monoxide, radon, formaldehyde, oxides of nitrogen, and oxides of sulfur within the structure.

18. An indoor air quality (IAQ) system comprising:
a plurality of air quality sensor modules configured to sense IAQ parameters and remotely located within the structure; and
an IAQ control hub including (i) a communication interface communicatively coupling the IAQ control hub to the plurality of air quality sensor modules and (ii) memory holding instructions that cause a processor to:
receive the IAQ parameters from the plurality of air quality sensor modules; and
if one of the IAQ parameters is outside a predetermined IAQ parameter range corresponding to the one of the IAQ parameters, request cooperative adjustment of control settings of multiple distinct heating, ventilation, and air conditioning (HVAC) devices included in a HVAC system to shift indoor air quality toward the predetermined IAQ parameter range.

19. The IAQ system of claim 18, where IAQ parameters include a concentration of one or more of volatile organic compounds, allergen particulates, mold, carbon dioxide, carbon monoxide, radon, formaldehyde, oxides of nitrogen, and oxides of sulfur within the structure.

20. The IAQ system of claim 18, where one of the air quality sensor modules is a wearable sensor module configured to secure to a user, the wearable sensor module configured to sense one of the IAQ parameters and where the request for cooperative adjustment of the control settings is based on a dynamic location of the wearable sensor module in the structure associated with the IAQ parameter sensed by the wearable sensor module.
